(19) United States
(12) Patent Application Publication
(10) Pub. No.: US 2024/0352776 A1
(43) Pub. Date: Oct. 24, 2024

(54) SLIDABLE PANE SYSTEM, WINDOW, DOOR, AND INSTALLATION METHOD

(71) Applicant: CORNING INCORPORATED, CORNING, NY (US)

(72) Inventors: Julia Madeline Allen, Corning, NY (US); Thomas Bertin-Mourot, Paris (FR); Stephen Joseph Caracci, Elmira, NY (US)

(21) Appl. No.: 18/642,102

(22) Filed: Apr. 22, 2024

Related U.S. Application Data
(60) Provisional application No. 63/461,347, filed on Apr. 24, 2023.

(51) Int. Cl. E05D 15/06; E06B 9/24

(52) U.S. Cl. CPC E05D 15/0643; E05Y 2800/122; E06B 2009/2464

(57) ABSTRACT

A slidable pane system includes a slidable pane, at least one track, and a conductor. The slidable pane has an electrically adjustable optical characteristic in response to at least one signal. The at least one track defines the sliding path of the slidable pane. The conductor has an adjustable length along the sliding path of the slidable pane and is electrically coupled to the slidable pane to bridge at least one of the at least one signal or power to the slidable pane.

### CROSS-REFERENCE TO RELATED APPLICATIONS

This application claims the benefit of priority under 35 U.S.C. § 119 of U.S. Provisional Application No. 63/461,347 filed Apr. 24, 2023, the content of which is incorporated herein by reference in its entirety.

### TECHNICAL FIELD

This disclosure is generally related to slidable pane systems, and more particularly to sliding pane systems driven by at least one external signal or power.

### BACKGROUND

Sliding panes, such as sliding windows or doors, or other slidable building components, are widely used on buildings. As shown in FIG. 12, these sliding panes may include substrates 90 with adjustable optical characteristics, such as adjustable tint level or transparency. For example, these substrates 90 can sandwich different types of materials 91, such as liquid crystal. The material in the substrate may be responsive to the voltage, current, or different kinds of electrical signal(s). The substrates 90 may be configured with a frame 92 surrounding the substrates 90.

### SUMMARY

This summary is a brief description of certain aspects of this disclosure. It is not intended to limit the scope of this disclosure.

Some embodiments of this disclosure provide a slidable pane system, including a slidable pane having an adjustable optical characteristic in response to at least one signal; and a conductor, having an adjustable length along a sliding path of the slidable pane and electrically coupled to the slidable pane to bridge at least one of the at least one signal or power to the slidable pane.

Some other embodiments of this disclosure provide a building structure, which includes a slidable pane system according to any one of the preceding claims; and a driver configured to provide at least one of the at least one signal or power to control the optical characteristic of the slidable pane via the conductor.

Some other embodiments of this disclosure provide method of installing slidable pane systems disclosed herein. The method includes installing the slidable pane; coupling the slidable optical pane to the length-adjustable conductor; and coupling the conductor to a source of at least one of the at least one signal or power.

Some embodiments of this disclosure provide a slidable pane system adapted to receive at least one of at least one signal or power from a driver. The slidable pane system includes a slidable optical pane having an adjustable optical characteristic in response to the at least one signal; and a collectable wire coupled between the slidable pane and the driver.

Some embodiments of this disclosure provide a slidable pane system adapted to receive at least one of at least one signal or power from a driver. The slidable pane system includes a slidable pane having an adjustable optical characteristic in response to at least one signal; and a conductive track defining a sliding path of the slidable pane and providing a conductive path between the driver and the slidable pane.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows a slidable pane system according to embodiments of the present disclosure;

FIG. 2 shows the slidable pane systems of FIG. 1 after a sliding movement;

FIG. 3 shows a slidable pane system according to embodiments of the present disclosure;

FIG. 4 shows a slidable pane system according to embodiments of the present disclosure;

FIGS. 5A and 5B show exemplary wiring components applicable to the embodiments of the present disclosure;

FIGS. 6A and 6B compare a slidable pane system with the slidable pane at two different locations;

FIGS. 7A and 7B compare another slidable pane system with the slidable pane at two different locations;

FIGS. 8A and 8B show another embodiment of the slidable pane system with the slidable pane at different locations;

FIGS. 9A and 9B show embodiments of the slidable pane system with the slidable pane at different locations;

FIG. 10A shows a slidable pane system according to embodiments of the present disclosure;

FIGS. 10B-10D show side view of slidable pane systems according to embodiments of the present disclosure;

FIG. 10E shows an enlarged partial view of a slidable pane system according to embodiments of the present disclosure;

FIG. 10F shows a perspective view of a component according to embodiments of the present disclosure;

FIG. 11A shows a slidable pane system according to embodiments of the present disclosure;

FIG. 11B shows a side view of the slidable pane system of FIG. 11A; and

FIG. 12 shows an exemplary slidable pane applicable to embodiments of the slidable pane systems of the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub ranges such as from 1-3, from 2-4, from 3-5, etc., as well as 1, 2, 3, 4, and 5 individually. The same principle applies to ranges reciting only one numerical value as a minimum or maximum. Furthermore, such an interpretation should apply regardless of the breadth of the range or the characteristics being described by the range.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Smart window/door technology can use liquid crystal material, or other kinds of material, whose transparency can be adjusted according to the electrical characteristic applied on the smart windows or doors. The smart windows and doors, for example, can be driven by an AC (Alternating Current) RMS voltage. Smart windows or doors can be configured as some types of sliding windows or doors, and the driving signal(s) or the power of the sliding windows or doors may be supplied from a driver detached from the moving part of the sliding windows or doors. The embodiments of slidable pane systems in this disclosure can be used as, but not limited to, sliding windows or doors.

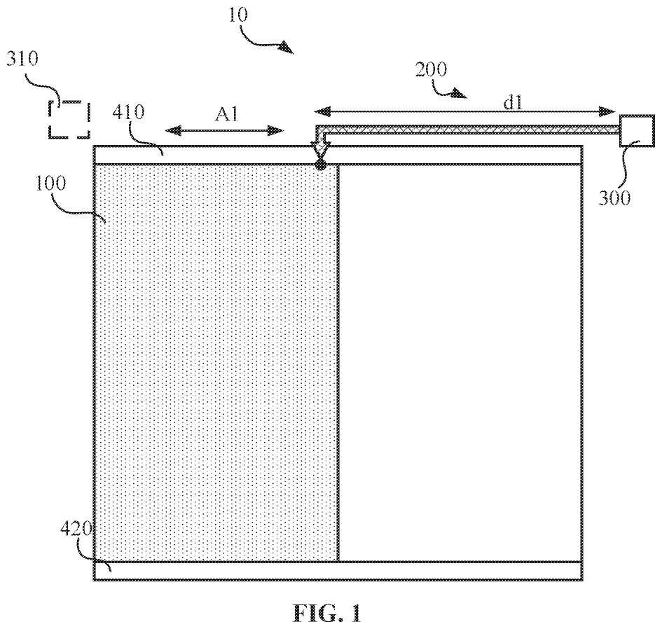

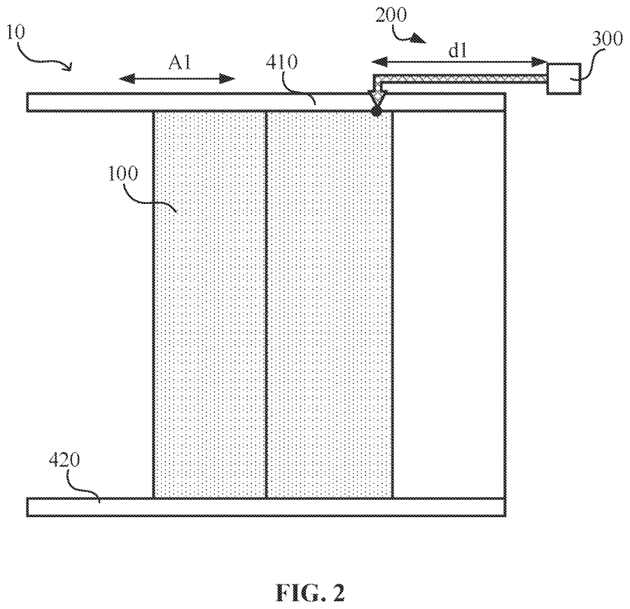

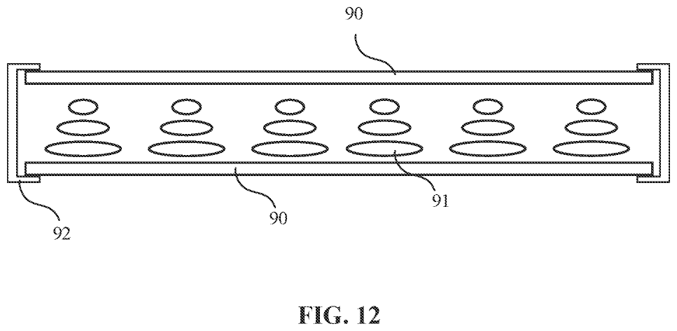

According to some embodiments of this disclosure, a slidable pane system 10 is discloses. As shown in FIG. 1 and FIG. 2, the slidable pane system may include a slidable pane 100 (exemplarily shown in FIG. 12) and a conductor 200. The conductor 200 may be electrically coupled to the slidable pane 100 and configured to provide one or more signals, such as a command signal that controls the optical characteristics of the slidable pane 100 and/or to provide power of the slidable pane 100. According to some examples, the conductor 200 may provide adjustable length adaptive to the movement of the slidable pane 100.

The signal(s) and the power can be provided by a driver 300 of the slidable pane 100. The driver 300 can be implemented by, for example, a power converter and/or a micro controller. The power converter may include at least one of a DC/DC converter, a DC/AC converter, an AC/AC converter, or an AC/DC converter. According to some embodiments, the driver 300 may be spaced apart from the slidable pane 100, therefore not moving with the slidable pane 100. For example, the driver 300 can be installed on a wall or on a rail of the slidable pane 100. Therefore, a distance between the driver 300 and the slidable pane 100 may change along with the sliding of the slidable pane 100.

For example, as shown in FIG. 1 and FIG. 2, the slidable pane 100 of the slidable pane system 10 can slide or move along the sliding axis A1. The distance d1 between the slidable pane 100 and the driver 300 is smaller when the slidable pane 100 is (partially) open as shown in FIG. 2. The distance d1 is larger when the slidable pane 100 is closed as shown in FIG. 1. It should be noted that the slidable pane 100 can be used for various purposes, such as serving as windows or doors. The sliding axis is not necessarily along a horizontal direction. For example, the slidable pane system 10 in this disclosure can serve as a hung window with a vertical sliding axis. Also, in some cases when the driver 300 is installed on the left side (indicated as 310) of the slidable pane 100 in FIG. 1 and FIG. 2, the distance d1 between the driver 300 and the slidable pane 100 can be smaller when the slidable pane 100 is closed.

According to some embodiments of this disclosure, a slidable pane system is disclosed. The slidable pane system includes a slidable pane 100 having an adjustable optical characteristic in response to at least one signal; and a conductor 200, having an adjustable length along a sliding path of the slidable pane 100 and electrically coupled to the slidable pane 100 to bridge at least one of the at least one signal or power to the slidable pane 100. As explained in FIG. 1 and FIG. 2, the conductor 200 of the various slidable pane systems 10 have an adjustable length (like different values of d1 in FIG. 1 and FIG. 2).

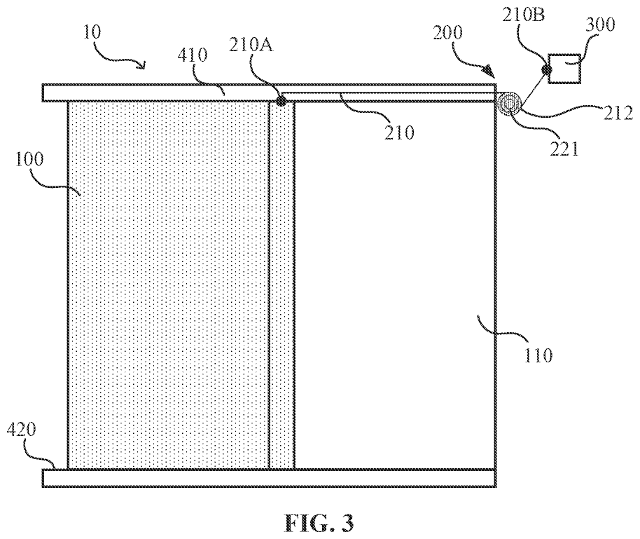

As show in FIG. 3, the slidable pane system 10 may include a slidable pane 100. The slidable pane 100 may have an electrically adjustable optical characteristic in response to at least one signal. The signals and the power used to drive the slidable pane 100 can be provided by a driver 300 of the optical pane 100. The slidable pane 100 may slide or move along a first rack 410 and a second track 420. For example, the first track 410 can be an upper track, and the second track 420 can be a lower track. The track 410 and the track 420 can be arranged horizontally or vertically, and the tracks 410 and 420 can be fixed on the wall or other external structures. The tracks 410, 420 may define the sliding path of the slidable pane 100. In addition, the slidable pane system 10 may have another pane 110. The pane 110 can be slidable or non-slidable. The other pane 110 may also have the electrically adjustable optical characteristic that can be controlled by the same driver 300 (or by another driver). The connection between the pane 110 and its driver can be a mirror or duplicate of that of the slidable pane 100 and the driver 300. It should be understandable that the arrangement disclosed herein for the slidable pane 100 should be applicable on the pane 110. To be concise, the basic structures, such as the tracks 410, 420 and the driver 300, can be implemented in other embodiments in this disclosure, and this disclosure does not repeat the same details below.

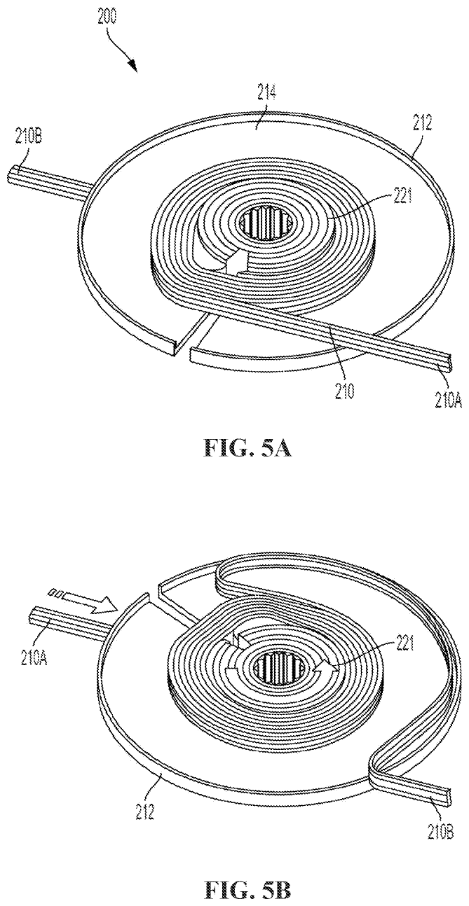

In the example in FIG. 3 with a reference to FIG. 5A, the conductor 200 includes a collectable wire 210. The collectable wire 210 may include a spool 221. The spool 221 can be situated in a housing 212. The spool 221 may retract the wire 210, or the wire 210 can be self-retractive to wind on the spool 221. According to some examples, the spool 221 may include a spring, such as a clock springs or a torsion spring at the center part of the spool 221, such that the spool 221 can wind the extra wire 210 along with the moving of the slidable pane 100 toward the driver 300. Alternatively or additionally, the collectable wire 210 can be self-retractive. For example, the collectable wire 210 may include rotary springs, and the rotary springs is pre-shaped to be retractive. According to one example, the collectable wire 210 can be made of elastic conductive metal shaped like a slim tape and coated with external insulation. The collectable wire 210 may thereby tend to retract around the spool 221 when the tension between the slidable pane 100 and the spools is released.

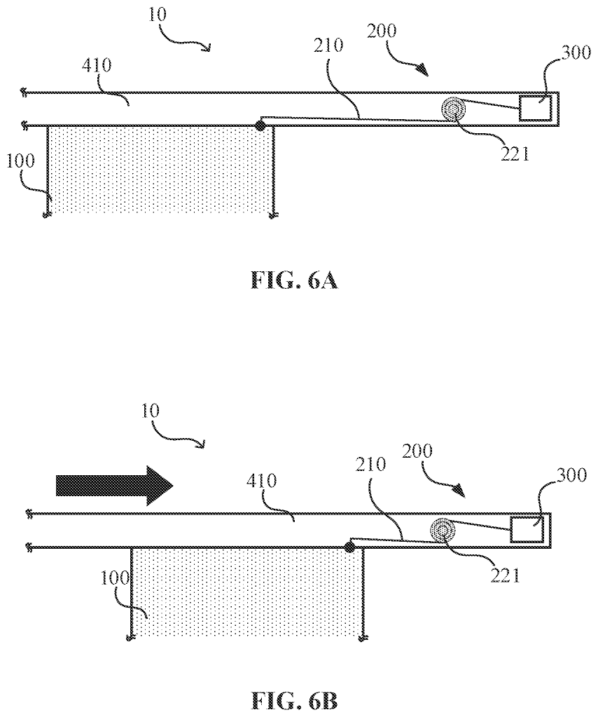

Comparing FIG. 6A and FIG. 6B, the slidable pane 100 slides closer to the spool 221 (or the driver 300) in the FIG. 6B. The arrow indicates the movement. In the case, the length of the wire 210 that is required to connected the slidable pane 100 and the driver 300 is shortened. Therefore, the spools can collect the wire 210 into the housing 212. Also as shown in FIG. 6A and FIG. 6B, in some embodiments, the spools and the wires can be at least partially situated in the track 410 or track 420. It should be noted that some components, such as track 420, are omitted from FIG. 6A and FIG. 6B and from various following figures for purposes of explanation.

As shown in FIG. 3, and FIG. 5A, the collectable wire 210 may include two terminals 210A and 210B. The two terminals 210A and 210B may be respectively connected to an input port of the slidable pane 100 and an output port of the driver 300. For example, the slidable pane 100 and the driver 300 may include sockets, which the terminal 210A and terminal 210B can be inserted into. As shown in FIG. 5A, the two terminals 210A and 210B may be configured at two different sides of a substrate 214 of the housing 212, but the two terminals 210A and 210B may also be configured at the same side of the substrate 214. FIG. 5B shows an up-side-down perspective view of the spool 221, the collectable wire 210, and housing 212. In this example, the spool 221 may go through the substrate 214 and can wind the collectable wire 210 on both sides of the substrate 214. The spool 221 located on both sides of the substrate 214 can respectively wind the collectable wire 210 on the both sides of the substrate 214, asynchronously or synchronously. In some implementations, it is sufficient to have the wire 210 retractable on only one side of the substrate 214. For example, as shown in FIG. 3, the driver 300 and the spool 221 can be fixed separately from the slidable pane 100. As the locations of the driver 300 and spool 221 are fixed, the connection between the driver 300 and the spool 221 need not to be extendable.

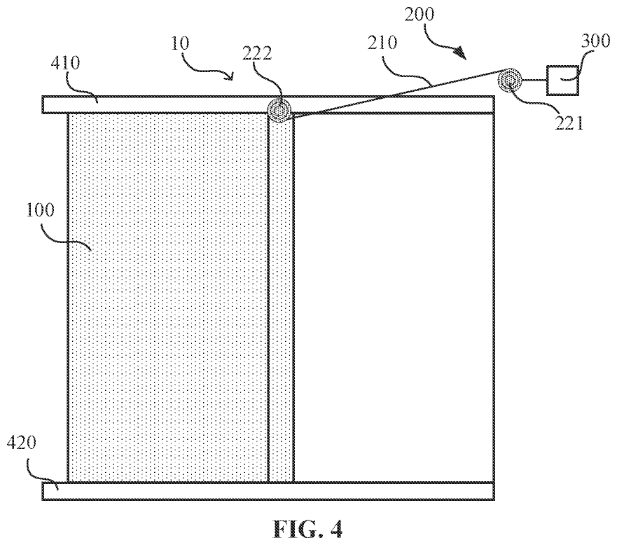

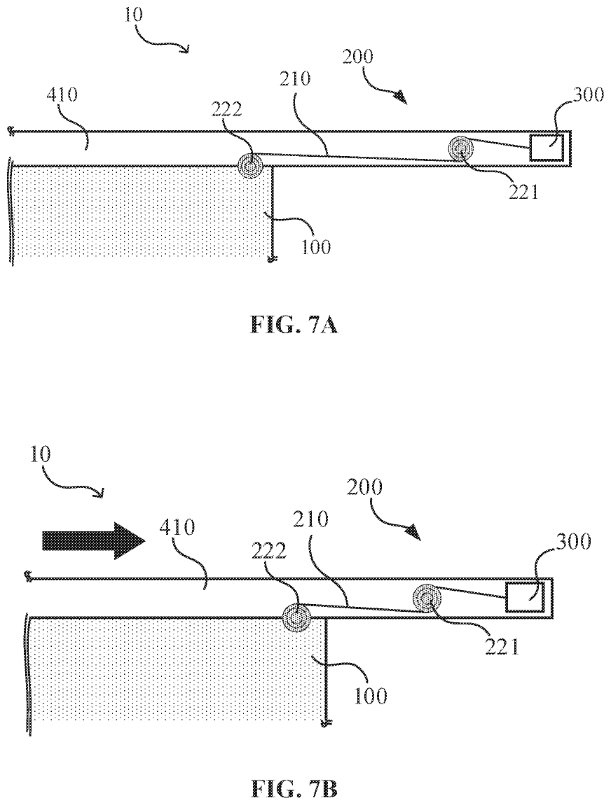

FIG. 4 shows another embodiment of this disclosure, where two spools 221, 222 are used. The spool 222 can be disposed with the slidable pane 100, such that the spool 222 may move with the slidable pane 100. The spool 221 may be disposed apart from the slidable pane 100. Therefore, the slidable pane 100 may move relatively with the spool 221 (like the spool 221 in FIGS. 3, 6A, and 6B). In this embodiment, the spool as shown in FIG. 5A and FIG. 5B is applicable for this arrangement. The spool 222 may be electrically coupled to the slidable pane 100 via a contact behind the spool 222. Likewise in comparison of FIG. 7A and FIG. 7B, the slidable pane 100 slides closer to the spool 221 (or the driver 300) in the FIG. 7B. In the case, the length of the wire 210 that is required to connect the slidable pane 100 and the driver 300 is shortened in FIG. 7B. Therefore, the spools 222, 221 can retract and collect the wire 210 into the housing 212 from both sides of the wire 210. Alternatively or additionally, the wire 210 may be self-retractive, so as to retract into the housing of the spools 222, 221 from the both sides of the wire 210. Also as shown in FIG. 7A and FIG. 7B, in some embodiments the spools, the wires, and/or the driver 300 can be at least partially situated in the track 410 or 420.

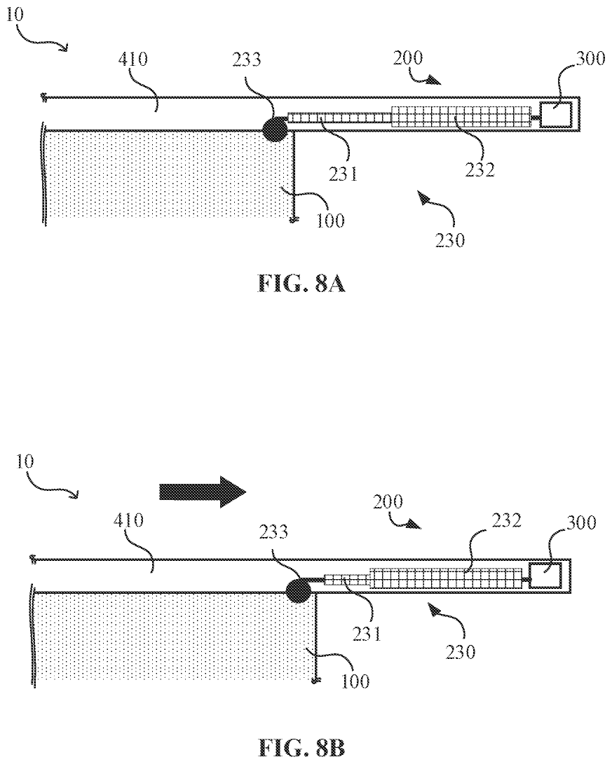

FIG. 8A and FIG. 8B show another embodiment of the slidable pane system with length-adjustable conductor 200. In this embodiment, the collectable conductor 200 may include a telescopic arm assembly 230. As examples, the telescopic arm assembly 230 may include at least two arms 231, 232, such as two cylinders or tubes. The arm 231 may be inserted into the arm 232, such that the arm 231 can move relatively with the arm 232 to collapse with each other and adjust the overall length of telescopic arm assembly 230 along with the movement of the slidable pane 100. As an example, the arm 231 and arm 232 may be electrically conductive. The arm 231 and arm 232 may be at least partially made of conductive materials (such as copper or other kinds of metals) or may include conductive materials disposed thereon. The conductive parts of the arm 231 and arm 232 may be electrically coupled with each other. Therefore, the signal(s) or power from the driver 300 can be transferred sequentially to the arm 232, the arm 231, and eventually to the slidable pane 100 via the connecting point 233.

Alternatively or additionally, the arm 231 and arm 232 may house a conductive cable (not shown) therein. The conductive cable may be electrically coupled between the driver 300 and the slidable pane 100 through the inside of the telescopic arm assembly 230. In addition, the telescopic arm assembly 230 may have an additional space to house the extra conductive cable when the slidable pane 100 is moved to a closer position to the driver 300, shorting the distance between the driver 300 and the connection point 233. Alternatively or additionally, the slidable pane system 10 in this embodiment may include a pulley assembly to provide a counterweight. The pulley assembly may be installed in the frame (such as the track 410). Thereby, an extra wire length would not get stuck in the tubing, frame, or on itself and impact the ability to open and close the slidable pane 100.

Likewise in comparison of FIG. 8A and FIG. 8B, the slidable pane 100 slides closer to the driver 300 in the FIG. 8B. In the case, the arm 231 collapses with the arm 232 when being inserted into the arm 232. As shown in FIG. 8A and FIG. 8B, the telescopic arm assembly 230 and the driver 300 of some embodiments of this disclosure can be at least partially situated in the track 410 or 420.

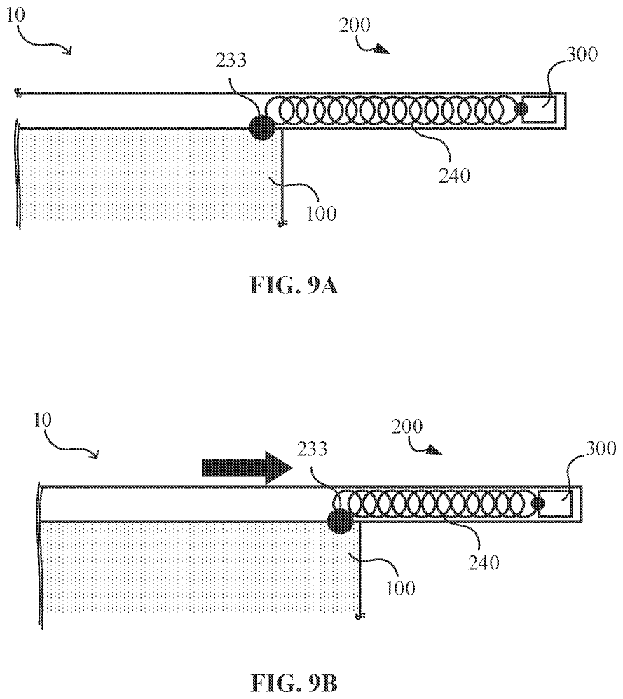

FIG. 9A and FIG. 9B show still another embodiment of the slidable pane system with length-adjustable conductor 200. In this embodiment, the conductor 200 may include a conductive spring 240. The conductive spring 240 may include at least one of a tension spring, a compression spring, or a helical spring disposed between the driver 300 and a connection point 233 of the slidable pane 100. For example, one end of the spring 240 may be connected (directly or indirectly) to the driver 300 to receive the signal(s) or power from the driver 300, and the other end of the spring 240 may be connected (directly or indirectly) to the slidable pane 100 to deliver the signal(s) or power to the slidable pane 100. As an example, the conductive spring 240 may have a low spring constant, so that the conductive spring 240 is capable of stretching without creating a force that could impact the intended motion of the pane. But the spring constant should still be sufficient to collect the expanded conductive spring 240 once the tension between the driver 300 and the slidable pane 100 is released. For example, the spring constant of the conductive spring 240 can be between 0.3 N/m to 20 N/m. Particularly, the spring constant of the conductive spring 240 preferably can be below 2 N/m and even preferably below 0.75 N/m. Particularly, the embodiments of FIG. 9A and FIG. 9B with a spring can be used in an application of a vertical sliding path, like a hung window.

Likewise in comparison of FIG. 9A and FIG. 9B, the slidable pane 100 slides closer to the driver 300 in the FIG. 9B. In the case, the conductive spring retracts, and the overall length along the axis A1 is shortened. As shown in FIG. 9A and FIG. 9B, the conductive spring 240 and the driver 300 of some embodiments of this disclosure can be at least partially situated in the track 410 or 420.

According to some embodiments of this disclosure, the length-adjustable conductor may be formed by a conductive track, which may at least partially define the sliding path of the slidable pane 100 or at least substantially extend along the sliding path of the slidable pane 100. Because the track is conductive, it can provide a route to transfer the signal(s) or the power to the slidable pane 100 when the slidable pane 100 is moving along the sliding path.

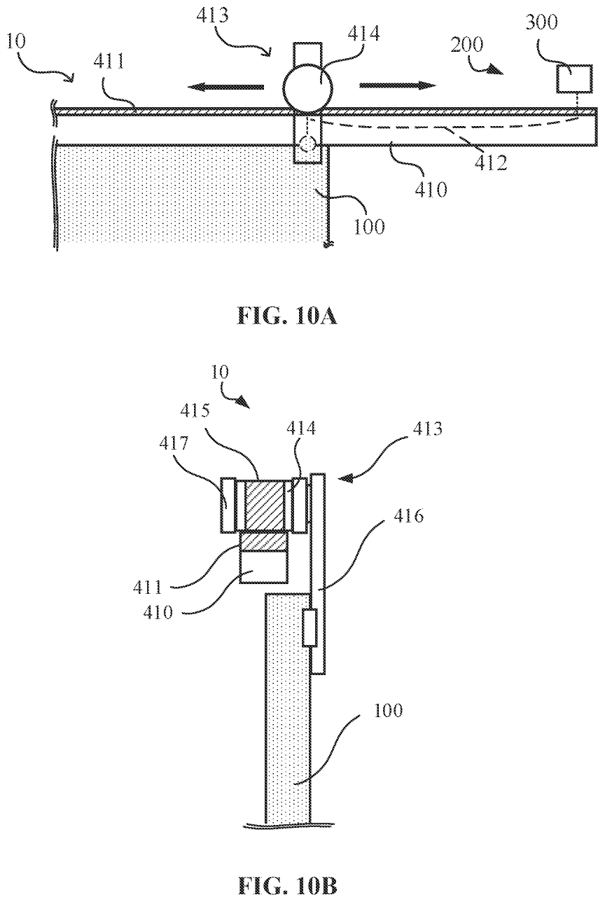

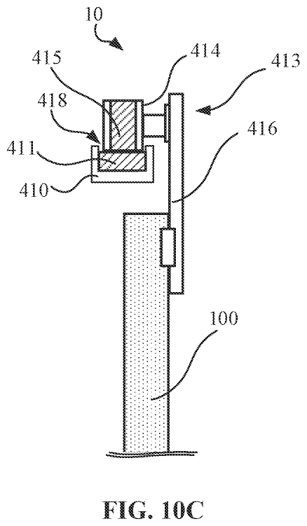

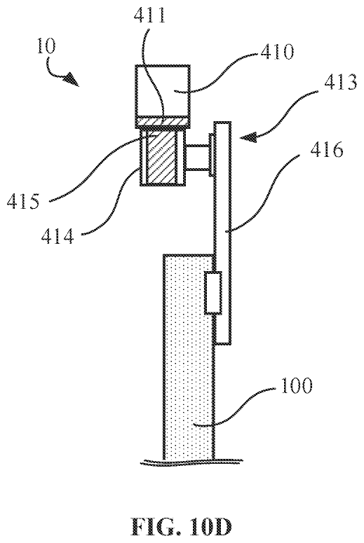

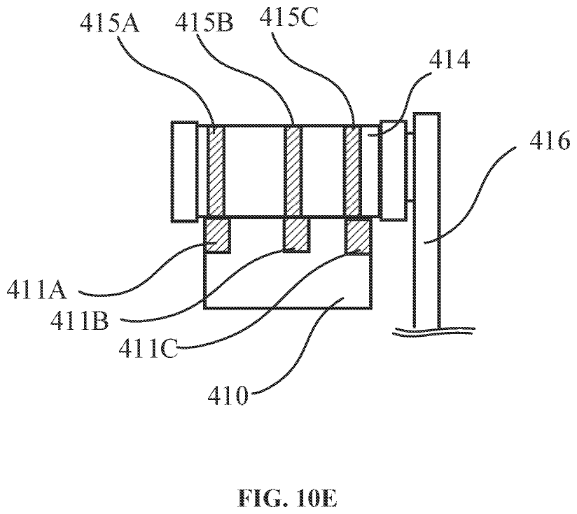

FIG. 10A shows an embodiment of slidable pane system of this disclosure. In this example, the slidable pane 100 is electrically coupled to the track 410; the track 410 is conductive at least at some part of the track 410. A conductive path 411 can be disposed on the track 410, and an end of the conductive path 411 may receive at least one of the signal or power for the driver 300. It should be noted that the conductive path 411 may be disposed on the other track 420. The term “end” in this disclose does not necessarily mean the ultimate terminal of an object, but it may reference to an intermediate point of an object. The slidable pane 100 may be coupled to the conductive path 411 via an intermediate structure, such as a hanger 413. An end of the hanger 413 can be coupled to the slidable pane 100, and the other end can be coupled to the conductive path 411 via a structure facilitating the movement of the slidable pane 100. For example, the hanger 413 can be riveted with the slidable pane 100. The hanger 413 may include a roller 414. The roller 414 may roll along the conductive track 410 and have a contact with the conductive path 411. Therefore, at least a part (indicated as 412) of the conductive path 411 may act as a conductor to deliver the signal(s) and/or power from the driver 300 to the slidable pane 100. It is understandable that the length of the conductor 412 is changing according to the location of the roller 414.

FIGS. 10B, 10C, and 10D show a side view of different embodiments related to the embodiment in FIG. 10A. In FIG. 10B, the roller 414 has a smaller diameter at the center portion, such that the shrunk portion can help the roller 414 maintain its position on the track 410. The roller 414 may have a conductive surface 415 at least at the center portion. The conductive surface 415 may contact the conductive path 411 on the track 410. The roller 414 may be electrically coupled to the slidable pane 100 via an arm 416 of the hanger 413. Therefore, at least one of the at least one signal or power can be transferred from the driver 300 to the conductive path 411, then to the roller 414, and eventually to the slidable pane 100 to drive and control the slidable pane 100. The conductive path 411 can be made of a metal piece disposed on the track 410. The part of the track 410 under the conductive path 411 may be electrically insulated. Similarly, the both sides 417 of the roller 410 may include an electrical insulation to prevent the electric shock or leakage of the signal or power. FIG. 10F shows a perspective view of an exemplary hanger with a roller that may be applicable to the current applications in this disclosure.

In FIG. 10C, the slidable pane system 10 works basically similar to the structure in FIG. 10A and FIG. 10B. But, the track 410 here may include a U-shaped groove 418. The groove 418 may be used to define the sliding path of the slidable pane 100 by maintaining the roller 414 therein. The conductive path 411 may be situated in the groove 418, and the shell of the groove 418 may be electrically insulated to isolated the conductive path 411. FIG. 10D shows another variation of the similar structures. Here, conductive path 411 faces toward the slidable pane 100, not away from the slidable pane 100 like previous embodiments. In this embodiment, the roller 414 is positionable under the track 410 and is coupled to the conductive path 411 at the bottom of the track 410. Like other embodiments in this disclosure, the conductor 200 may provide at least one of one or more signals and/or power to the slidable pane 100. FIG. 10E shows an enlarged view of the track 410 and the roller 414. Here the conductive path 411 includes two or more sub-paths 411A, 411B, 411C. The sub-paths 411A, 411B, 411C may be electrically isolated from each other, such that each of them can be used to transfer a separate signal or power. Correspondingly, the roller 414 may include separate conductive points 415A, 415B, 415C to receive different signals or power. The separate conductive sub-paths may be applied to different embodiments in this disclosure.

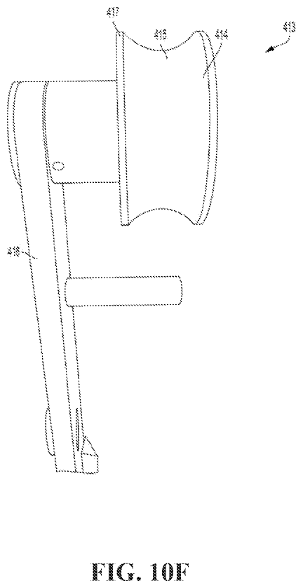

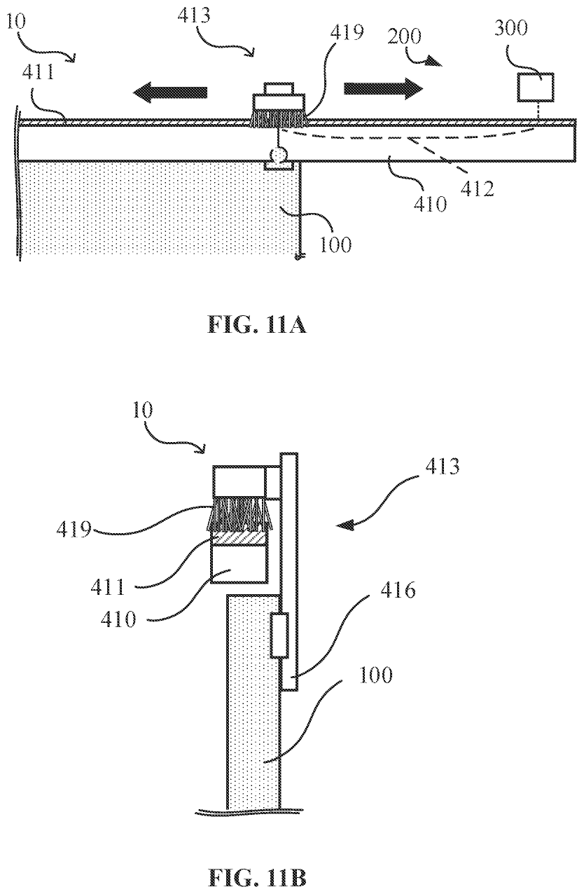

FIG. 11A shows another embodiment of this disclosure where the length-adjustable conductor 200 may be formed by a conductive track 410, which may at least partially define the sliding path of the slidable pane 100 or at least substantially extend along the sliding path of the slidable pane 100. Because the track 410 is conductive, it can provide a route to transfer the signal(s) or the power to the slidable pane 100 when the slidable pane 100 is moving along the sliding path. FIG. 11B shows a side view of FIG. 11A. Similar to the last few embodiments, the embodiment here has a track 410 with a conductive portion. For example, the top layer of the track 410 has a conductive path 411. In this example, the slidable pane 100 is electrically coupled to the track 410 via an arm 416 of the hanger 413. A conductive path 411 can be disposed on the track 410, and an end of the conductive path 411 may receive at least one of the signal or power from the driver 300. The slidable pane 100 may be coupled to the conductive path by an intermediate structure, such as a hanger 413. An end of the hanger 413 can be coupled to the slidable pane 10, and the other end can be coupled to the conductive path 411 via a structure facilitating the movement of the slidable pane 100. For example, the hanger 413 can be riveted with the slidable pane 100.

The hanger 413 may include a deformative conductor 419. The deformative conductor 419 may have the flexibility to help the movement of the slidable pane 100 along the conductive track 410. The deformative conductor 419 may be deformed due to the weight or the force of slidable pane 100. As examples, the deformative conductor 419 may include at least one of a conductive bristle, a conductive foam, or a conductive rubber. A conductive bristle may be a brush made of metal material. A conductive foam or a conductive rubber may be a foam or rubber added with metallic materials. The deformative conductor 419 may be self-lubricating to provide a smooth sliding function of the slidable pane 100. Also, the track 420 may bear most weight of the slidable pane 100, so deformative conductor 419 can properly touch the conductive path 411. The deformative conductor 419 may contact the conductive path 411 on the track 410. Therefore, at least one of the at least one signal or power can be transferred from the driver 300 to the conductive path 411, and then to the deformative conductor 419. The deformative conductor 419 may be electrically coupled to the slidable pane 100 via an arm 416 of the hanger 413. Therefore, the at least one of the at least one signal or power can be provided to the slidable pane 100 to drive or control the slidable pane 100. The conductive path 411 can be made of a metal piece disposed on the track 410. The part of the track 410 under the conductive path 411 may be electrically insulated.

The slidable pane systems 10 in this disclosure may work with different kinds of driver 300. In some case, a slidable pane system 10 may also include an integrated driver 300. To install the slidable pane systems 10 in this disclosure, a user may install the slidable pane 100 by mounting it onto the track 410 and/or track 420; couple the slidable pane 100 to the conductor 200, e.g., to the conductive path 411 via the hanger or the collectable wire 210; and couple the conductor 200 to a source of at least one of the at least one signal or power, such as the driver 300.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that comprises instructions executable with the processor or other processors to implement one or more of the features of the logical components. When any one of the logical components includes the portion of the memory that comprises instructions executable with the processor, the logical component may or may not include the processor. In some examples, each logical component may just be the portion of the memory or other physical memory that comprises instructions executable with the processor or other processor to implement the features of the corresponding logical component without the logical component including any other hardware. Because each logical component includes at least some hardware even when the included hardware comprises software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

Various exemplary embodiments of the present disclosure are described below with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application. For example, a disclosure of a sub-combination can be applied to a variety of disclosed combination in the present disclosure. Two sub-combinations as disclosed can be combined to form a new combination. A method in the present disclosure can be implemented by or implemented on each disclosed device, if applicable.

It is to be understood that this disclosure is not limited to the precise structures or operation described above and shown in the accompanying drawings, and various modifications and changes may be made without departing from the scope of this application. The scope of this application is subject only to the appended claims.

What is claimed is:

1. A slidable pane system, comprising:
a slidable pane having an electrically adjustable optical characteristic in response to at least one signal;
at least one track defining a sliding path of the slidable pane; and
a conductor having an adjustable length along the sliding path of the slidable pane and electrically coupled to the slidable pane to bridge at least one of the at least one signal or power to the slidable pane.

2. The slidable pane system of claim 1, wherein the conductor includes a collectable conductive wire.

3. The slidable pane system of claim 2, further comprising one or more of:
a housing storing at least a part of the collectable conductive wire, and
a first spool in the housing to wind the collectable conductive wire around the first spool in the housing.

4. The slidable pane system of claims 3, wherein the housing is disposed spaced away from the slidable pane.

5. The slidable pane system of claim 2, further comprising a plurality of housings to store the collectable conductive wire, the housings comprising a first housing spaced away from the slidable pane and a second housing attached to the slidable pane.

6. The slidable pane system of claim 5, further comprising: a first spool in the first housing to store the collectable conductive wire from a first end of the collectable conductive wire; and a second spool in the second housing to store the collectable conductive wire from a second end of the collectable conductive wire.

7. The slidable pane system of claim 2, wherein the collectable conductive wire is self-retractive with elasticity of the collectable conductive wire.

8. The slidable pane system of claim 1, wherein the conductor includes a telescopic arm assembly with an adjustable length.

9. The slidable pane system of claim 8, wherein one or more of:
the telescopic arm assembly includes a first arm and a second arm, the second arm collapsible with the first arm,
the telescopic arm assembly is at least partially conductive, and
the telescopic arm assembly houses at least a conductive wire therein.

10. The slidable pane system of claim 1, wherein the conductor includes a conductive spring having a first end electrically coupled to the slidable pane and a second end to receive the at least one signal or the power.

11. The slidable pane system of claim 1, wherein the track includes a conductive path to serve as the conductor.

12. The slidable pane system of claim 11, wherein slidable pane system further comprises a roller moving along the conductive path to receive at least one of the at least one signal or the power from the conductive path.

13. The slidable pane system of claim 12, wherein one or more of:
the track comprises a horizontal member, and the roller is positionable above or below the track in contiguous contact with the horizontal member, and
the roller is electrically coupled to the slidable pane via an arm assembly, the arm assembly being coupled with the slidable pane.

14. The slidable pane system of claim 1, wherein the track includes a conductive path to serve as the conductor; and the slidable pane system further comprises a deformative conductor positionable to couple to the conductive path to receive at least one of the at least one signal or the power from the conductive path.

15. The slidable pane system of claim 14, wherein one or more of:
the deformative conductor includes at least one of a conductive bristle, a conductive foam, or a conductive rubber,
the track comprises a longitudinally-extending horizontal member, and the deformative conductor is positionable above or below the horizontal member, and
the deformative conductor is coupled to the slidable pane via an arm assembly.

16. The slidable pane system of claim 1, wherein the optical characteristic includes at least one of a transparency or color of the slidable pane.

17. A method of installing a slidable pane system, the slidable pane system comprising a slidable pane having an electrically adjustable optical characteristic in response to at least one signal, at least one track defining a sliding path of the slidable pane, and a conductor having an adjustable length along the sliding path of the slidable pane and electrically coupled to the slidable pane to bridge at least one of the at least one signal or power to the slidable pane, the method comprising:
installing the slidable pane;
coupling the slidable pane to the conductor; and
coupling the conductor to a source of at least one of the at least one signal or power.

18. A slidable pane system adapted to receive at least one of at least one signal or power from a driver, the slidable pane system comprising:
a slidable pane having an electrically adjustable optical characteristic in response to the at least one signal; and
one of a (i) a collectable wire coupled between the slidable pane and the driver or (ii) a conductive track defining a sliding path of the slidable pane and providing a conductive path between the driver and the slidable pane.

19. The slidable pane system of claim 18, wherein, when the slidable pane system comprises the collectable wire, the collectable wire includes at least one of a conductive helical spring, a conductive rotary spring, a conductive telescopic arm assembly, or a winding spool.

20. The slidable pane system of claim 18, further comprising a deformative conductor or a roller electrically coupled to the conductive path when the slidable pane system comprises the conductive track,
wherein, when the slidable pane system comprises the roller, the roller has a conductive surface to receive at least one of the at least one signal or power, and
wherein, when the slidable pane system comprises the deformative conductor, the deformative conductor includes at least one of a conductive bristle, a conductive foam, or a conductive rubber.
